(19) United States
(12) Patent Application Publication
(10) Pub. No.: US 2007/0291015 A1
(43) Pub. Date: Dec. 20, 2007

(54) Portable terminal equipment

(76) Inventor: Eijiro Mori, Tokyo (JP)

Correspondence Address: FROMMER LAWRENCE & HAUG LLP, 745 FIFTH AVENUE, NEW YORK, NY, 10151, US

(21) Appl. No.: 11/818,862

(22) Filed: Jun. 15, 2007

(30) Foreign Application Priority Data
Jun. 19, 2006 (JP) P2006-169136

(51) Int. Cl. G06F 3/041

(52) U.S. Cl. 345/173

(57) ABSTRACT

Portable terminal equipment contains plane display device made of a transparent or translucent material and a touch sensor made of a transparent or translucent material. The touch sensor mounts the plane display device. The portable terminal equipment also contains a casing that holds the plane display device by fastening the plane display device from both sides thereof.

### CROSS REFERENCE TO RELATED APPLICATION

The present invention contains subject matter related to Japanese Patent Application JP 2006-169 filed in the Japanese Patent Office on Jun. 19, 2006, the entire contents of which being incorporated herein by reference.

### BACKGROUND OF THE INVENTION

1. Field of the Invention

This invention relates to portable terminal equipment such as a personal digital assistant (PDA) or a mobile telephone.

2. Description of Related Art

Terminal equipment has been developed as compact and lightweight information-processing device. Portable terminal equipment such as PDA having a display area of a display panel for displaying any information as large as possible has also been developed.

On such the portable terminal equipment, a user manipulates any input operations by means of touch of his or her fingertip or a stylus on a screen of the display panel in the display device with a body of the portable terminal equipment being held by his or her hand or hands. This causes any tendencies to block his or her view from the screen of the display panel with his or her hand or hands whatever he or she may do, thereby tending to interrupt any information with his or her hand or hands.

Japanese Patent Application Publication No. 2003-58316 has discloses portable terminal equipment in which a touch panel is operable by touching a rear side of the touch panel. If the touch panel is designed so that it can be positioned at a rear side of the body of the portable terminal equipment, it is difficult for a user to view an operation (touch) position on the touch panel which is positioned at the rear side of the body of the portable terminal equipment. In this publication, a pointer such as a cursor appears on a screen of the display panel to identify the operation (touch) position.

Japanese Patent Application Publication No. 2003-273995 has disclosed portable equipment in which a touch switch is positioned at a rear side of a display screen. In this publication, a pointer such as a cursor also appears on the display screen to identify the operation (touch) position in the touch switch.

### SUMMARY OF THE INVENTION

In each of the above publications, a display element such as a liquid crystal, which is a light-reflecting element, is used as a display panel. In this moment, it is difficult to visually identify the operation position in the touch panel mounting the display panel through the display panel. Thus, the pointer may be required to appear on a screen of the display panel to identify the operation (touch) position in the touch panel by user's finger or the like.

Further, before the touch panel is touched, no cursor appears on the screen of the display panel so that it is difficult for the user to get an accurate grasp which location in the touch panel his or her finger is put on. After the touch panel has been touched, the cursor appears immediately and then a user can identify, through the screen of the display panel, a location of the touch panel on which his or her finger is put. This may cause a period of time for identifying the operation position of interest to be wasted because of its difficult immediate operability.

It is desirable to provide portable terminal equipment, operability of which is improved so that the user can operate the portable terminal equipment by touching the transparent touch panel mounting the transparent display panel by his or her finger or the like while he or she views it.

According to an embodiment of the present invention, there is provided portable terminal equipment containing plane display device made of a transparent or translucent material, a touch sensor made of a transparent or translucent material, which mounts the plane display device, and a casing that holds the plane display device by fastening the plane display device from its both sides.

In this embodiment of the invention, the portable terminal equipment contains the plane display device made of a transparent or translucent material and a touch sensor made of a transparent or translucent material, which mounts the plane display device. The plane display device is constituted of a transparent or translucent display panel and its display-driving mechanism.

When the display panel and the touch sensor are transparent, the user can view his or her finger, through the display panel, put on the touch sensor mounting the display panel while the portable terminal equipment is held by his or her hand or hands. When the display panel and the touch sensor are translucent, the user can view at least an outline of his or her finger, through the display panel, put on the touch sensor mounting the display panel while the portable terminal equipment is held by his or her hand or hands.

Even if an image is displayed on the display panel, the user can grasp a location relationship between this image and his or her finger(s) through the image. It, thus, is possible to identify the operation location in the touch sensor to be operated easily and accurately. The user's hand and/or finger does not block his or her view from the displayed image since, in this embodiment, the operation position in the touch panel is not identified from the front side of the display panel. As the plane display device made of a transparent or translucent material, an organic electroluminescent (EL) element or the like can be used.

According to the embodiment of this invention, the user can select one from switches or pieces of displayed information of interest easily by touching the touch sensor by his or her finger or the like from the rear side of the display panel while he or she views the image(s) displayed on the display panel. Thus, its operability can be improved without blocking the image displayed on a screen of the display panel by his or her hand or hands.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is an exploded perspective view of an embodiment of portable terminal equipment according to the invention for illustrating an important portion thereof;

FIG. 2 is a first diagram for illustrating a use condition of the portable terminal equipment;

FIG. 3 is a second diagram for illustrating a use condition of the portable terminal equipment;

FIG. 4 is a first diagram for illustrating a display condition on a screen of a display panel;

FIG. 5 is a diagram for illustrating a display condition of the display panel after a touch sensor is touched;

FIG. 6 is a second diagram for illustrating a display condition on the screen of the display panel;

FIG. 7 is a third diagram for illustrating a display condition on the screen of the display panel before scrolling;

FIG. 8 is a fourth diagram for illustrating a display condition on the screen of the display panel after scrolling;

FIG. 9 is a block diagram of an important portion of an embodiment of the portable terminal equipment according to the invention for showing a control system thereof;

FIG. 10 is a flowchart for showing an example of touch processing;

FIG. 11 is an exploded perspective view of another embodiment of portable terminal equipment according to the invention for illustrating an important portion thereof;

FIG. 12 is a first diagram for describing another touch sensor; and

FIG. 13 is a second diagram for describing the above another touch sensor.

### DESCRIPTION OF PREFERRED EMBODIMENTS

The following will describe preferred embodiments of portable terminal equipment according to the invention with reference to the attached drawings.

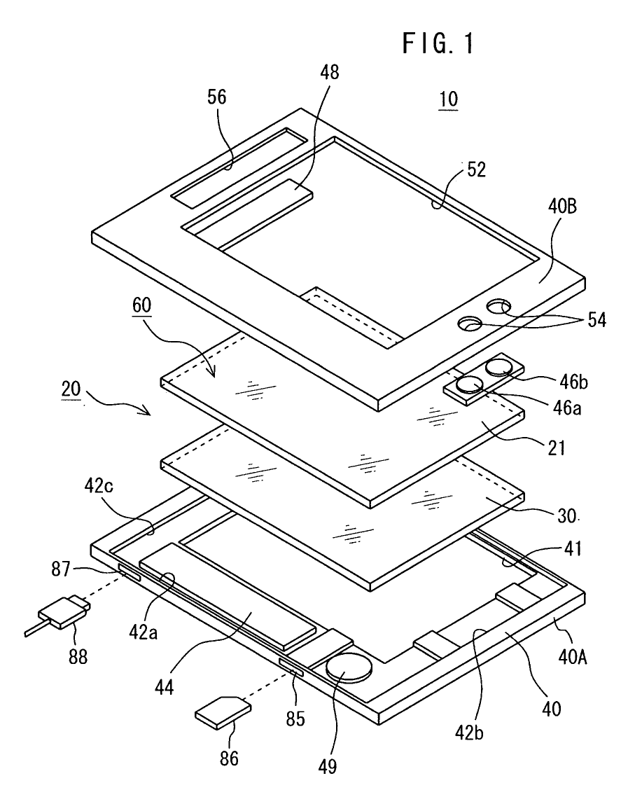

FIG. 1 illustrates an important portion of an embodiment of portable terminal equipment 10 according to the invention.

This portable terminal equipment 10 is constituted of transparent plane display device 20, a touch sensor 30 (touch screen) mounting the transparent plane display device 20, and a casing 40 that holds the plane display device 20 by sandwiching the plane display device 20 therebetween from both of upper and lower sides of the plane display device 20.

The plane display device 20 contains a transparent plane display panel 21 that emits light by itself, namely, is light-emitting device, and a control circuit board 44 as a display-driving mechanism therefor. The control circuit board 44 can be installed on the display panel 21. FIG. 1, however, illustrates a case where the control circuit board 44 is separately provided from the display panel 21.

In this embodiment, a display panel such as an organic EL element is used as the transparent display panel 21. A size of the plane display device 20 can be optionally set. In this embodiment, the plane display device 20 having some oblong screen size such as a television screen is illustrated.

A transparent touch sensor 30 mounts the display panel 21. The touch sensor 30 is a touch screen having a same size as that of the display panel 21 and has a transparent electrode installed. The display panel 21 and the touch sensor 30 constitute a touch panel. Touch (connection) on the touch sensor 30 can be detected by using any detection method such as capacitance detection method or thin film resistor detection method. In this embodiment, the thin film resistor detection is used.

A plane casing 40 installs and fixes the display panel 21 which the touch sensor 30 mounts. The casing 40 is constituted of a body 40A of the portable terminal equipment, which is positioned at a rear side of the display panel 21, and a cover 40B, which is positioned at a upper side of the display panel 21.

The body 40A is made of a nearly flat board having a size larger than that of the display panel 21, as shown in FIG. 1. The body 40A also has an opening 41, which is smaller than the display panel 21, at its middle portion. This allows the body 40A to mount and fix the display panel 21. Plural receiving recess portions 42a through 42c are formed inside a flame constituting an outer circumference of the body 40A. In a case shown in FIG. 1, the lower receiving recess portion 42a receives the control circuit board 44 constituted of any display-driving mechanism including any image control system on the display panel 21. Suppose that battery, built-in storage device (semiconductor memory) are installed in the control circuit board 44. Suppose that the storage device includes external storage device 86 that is removable from outside.

The receiving recess portion 42b formed at a right side of the body 40A receives first operation switches 46a, 46b, which will be described later, as well as the receiving recess portion 42c formed at a left side of the body 40A receives a second operation switch 48, respectively. In this embodiment, the first operation switches 46a, 46b, which are arranged back and forth, function as switches each for selection fix and for release of the switch, namely, the operation switch 46a functions as a selection fix switch and the operation switch 46b functions as a release switch.

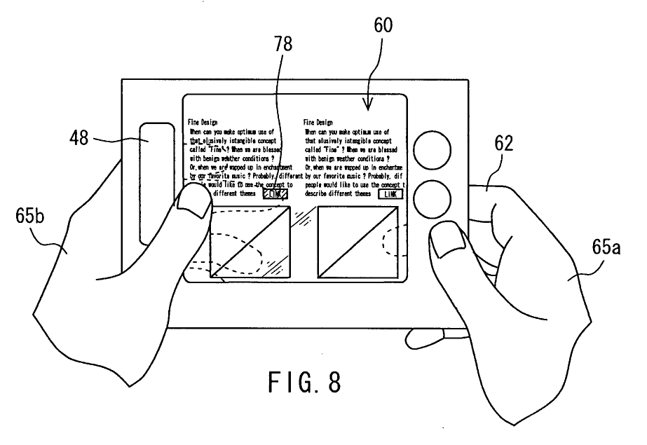

The second operation switch 48 functions as a scroll switch for scrolling a displayed image up and down on the screen of the display panel 21. When the user slides his or her finger upwards with the finger being touched on a surface of the second operation switch 48, the displayed image is scrolled up while when the user slides his or her finger downwards with the finger being touched on the surface of the second operation switch 48, the displayed image is scrolled down (see FIGS. 7 and 8). Although, in FIG. 1, only the second operation switch 48 that functions as a scroll switch for scrolling a displayed image up and down is shown, another operation switch that functions as a scroll switch for scrolling a displayed image right and left can be provided. The first operation switches 46a, 46b can function as such the scroll switch simultaneously.

The lower receiving recess portion 42a also receives and fixes a speaker 49. If the speaker is driven in synchronization with any user's touch manipulation in the operation switches 46a, 46b, 48 and the touch sensor 30, the touch and/or selection of these switches 46a, 46b, 48 can be noticed. On a front surface of the body 40A, a terminal 85 for allowing an external storage device (semiconductor memory) 86 and the like to be inserted, and a terminal 87 for allowing USB terminal 88 to be inserted can be prepared depending on the situation.

The cover 40B is mounted and fixed on the body 40A with the display panel 21 and the touch sensor 30 being mounted on the body 40A, and any electronic parts such as the control circuit board 44 being held in the recess portions 42a, 42b, and 42c of the body 40A. The cover 40B has a rectangular opening 52 having the same size as that of the opening 41 in the body 40A. The cover 40B also has apertures 54 for attaching the first operation switches 46a, 46b at positions of its right side facing to the first operation switches 46a, 46b. Each of the apertures 54 has a configuration such that it can match a configuration of each of the first operation switches 46a, 46b, a configuration of which is a circle in the illustrated embodiment. Similarly, the cover 40B also has a slot 56 for attaching the second operation switch 48 at a position of its left side facing to the second operation switch 48. The slot 56 has a configuration such that it can match a configuration of the second operation switch 48, a configuration of which is a long narrow slot configuration in the illustrated embodiment.

Thus, sandwiching the display panel 21, the touch sensor 30, and the like between the body 40A and the cover 40B allows to be realized the flat transparent portable terminal equipment 10, which is a handy tool. The body 40A has the terminal 85 for allowing an external storage device 86 to be inserted and the terminal 87 for allowing the USB terminal 88 that is connected to the Internet to be inserted, at its side setting the control circuit board 44.

Transparent protection films, not shown, may be mounted on a front surface of the display panel 21 and an exposed surface of the touch sensor 30, respectively, through the opening 41 of the body 40A and the opening 52 of the cover 40B, in order to protect the display panel 21 and the touch sensor 30. This enables any scratch-free portable terminal equipment to be realized.

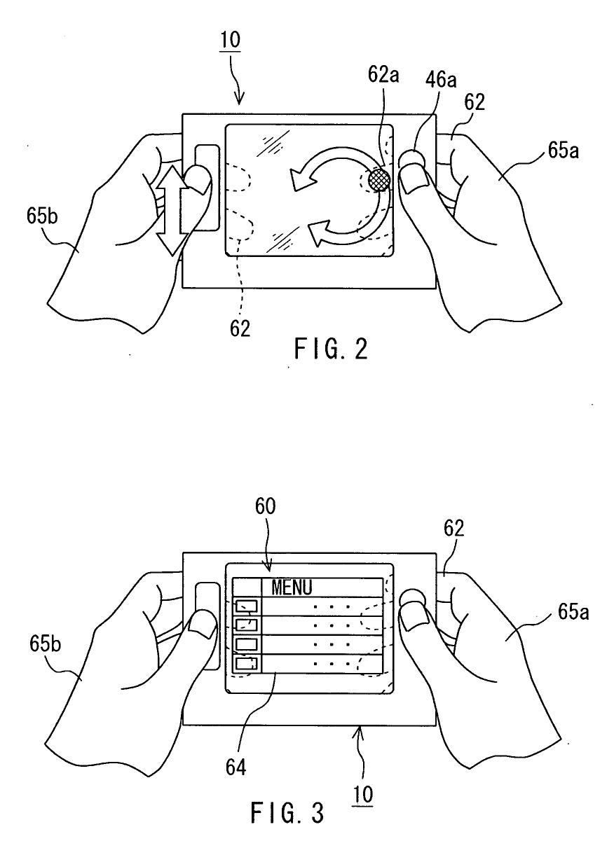

When the user actually uses the portable terminal equipment 10 thus configured, the user holds right and left side portions of the portable terminal equipment 10 with his or her right and left hands 65a, 65b, respectively, as shown in FIG. 2. Since the transparent display panel 21 and the transparent touch sensor 30 are provided, when the user holds the portable terminal equipment 10 with his or her hands 65a, 65b, any finger(s) positioned at a rear side of the display panel 21 can be viewed through the display panel 21 and the touch sensor 30. This enables a relative position relationship between an image displayed on a screen 60 of the display panel 21 and any fingers 62 of the right and left hands 65a, 65b to be easily and accurately grasped. In FIG. 2, fingers 62, which can be viewed through the display panel 21 and the touch sensor 30, positioned at the rear side of the display panel 21 are illustrated by dotted lines.

The finger 62 positioned at the rear side of the display panel 21 specifies (fixes) content from the displayed ones. In popular case, the user's middle finger often specifies the content. A position of the display panel 21 corresponding to a position of the touch sensor 30 that the finger 62 of the user touches is drawn any special attention to the user, for example, is highlighted, blinked, or displayed in a case of color representation with it's color being changed into a special color. This allows the user to recognize a touch position easily.

If the user moves his or her middle finger 62a of the right hand 65a circularly as shown in FIG. 2, the highlighted position on the screen 60 of the display panel 21 is changed and displayed according to the movement of the middle finger 62a or the color to be represented is displayed following the movement thereof. The user operates and selects any one of the first and second operation switches 46a, 46b, and 48, which are positioned near the display panel 21, to select and release the position of the touch sensor 30 that the finger(s) 62 of the user touches and to scroll the image displayed on the screen 60 on the display panel 21.

Thus, if the user selects and operates the first operation switch 46a with the user holding the portable terminal equipment 10 with his or her hands, as shown in FIG. 2, a menu screen 64 or the like appears first on a screen 60 of the display panel 21. FIG. 3 illustrates an example of representation of the menu screen 64. In this moment, even if the menu screen 64 or the like appears thereon, the finger(s) positioned at a rear side of the display panel 21 can be viewed through the displayed image, namely, the menu screen 64. This allows a present position of the finger 62 on the specified item of the menu screen 64 to be easily grasped if the image appears on the screen 60 of the display panel 21. As a result thereof, any pointer, for example, the pointers disclosed in the above Japanese patent publications, is not used in this embodiment, so that the finger 62 can be easily and quickly moved to displayed item(s) of interest. The user is not required to feel around the specified item with his or her fingertips some times, which is disclosed in the above Japanese patent publications. This allows the operability thereof to be improved.

It is to be easily comprehensible that such the characteristic that the finger 62 positioned at a rear side of the display panel 21 can be viewed even when the image appears on the screen 60 of the display panel 21 is not depended on any species of the displayed images and any displayed positions of the images thereof.

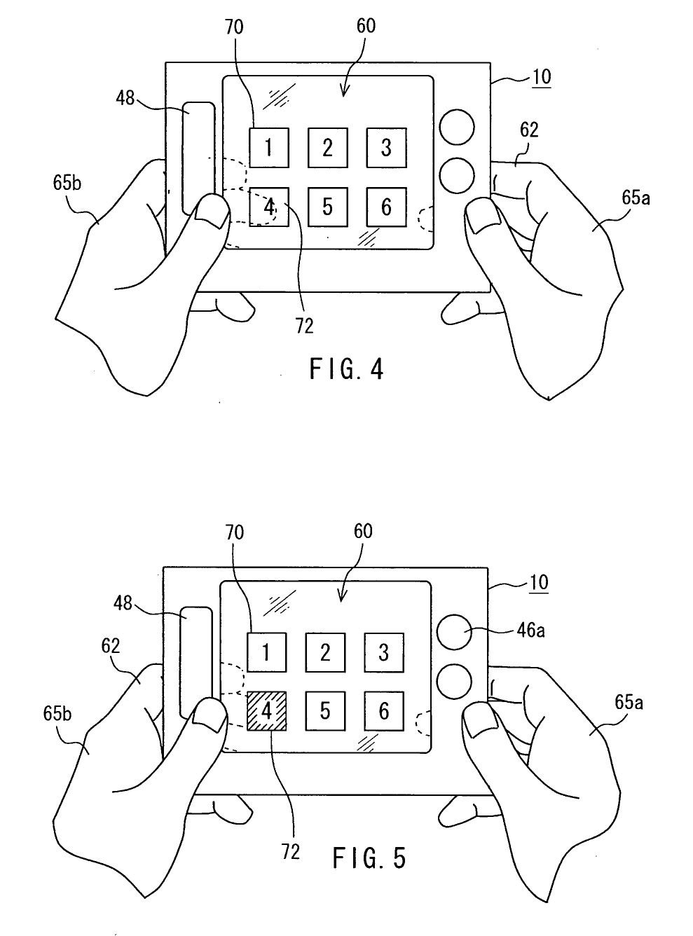

If bottoms 70 representing numbers as shown in FIG. 4 appear on the screen 60 of the display panel 21 and the finger 62 (middle finger 62a in this embodiment) touches a position of the touch sensor 30 corresponding to the display position of the display panel 21 that corresponds to the bottom 72 representing number, “4”, the bottom 72 is changed in its display condition as shown in FIG. 5. This enables the user to view a situation where the bottom 72 can be just selected. Such the selection of the bottom 72 at this touch position is fixed by operating and pushing the first operation switch 46a near the screen 60 of the display panel 21.

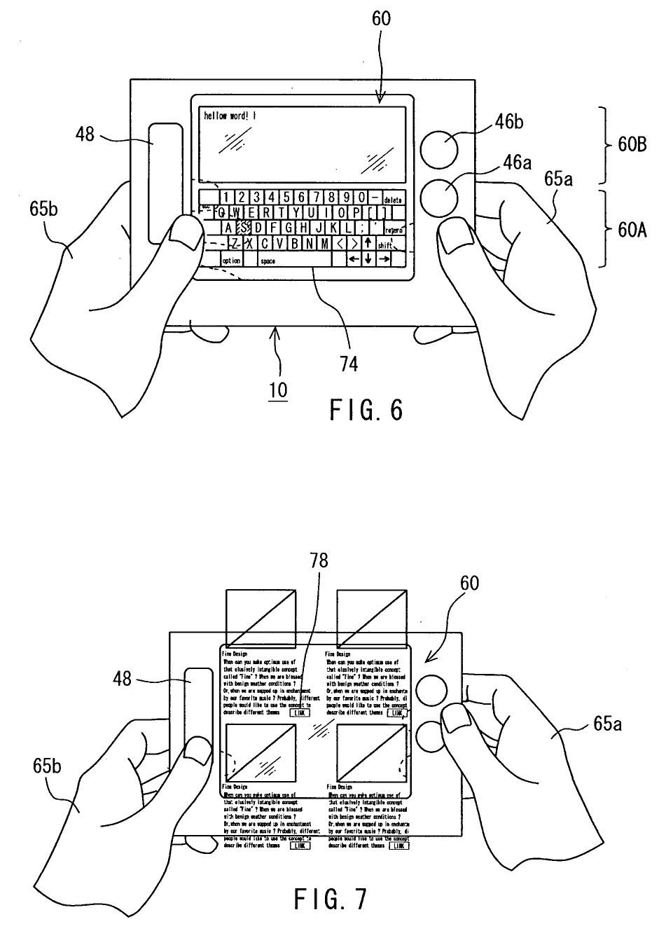

In FIG. 6, a software keyboard 74 appears on the screen 60 of the display panel 21 so that the user may create the text or the like with any keys of the software keyboard 74 being successively selected. A lower half of the screen 60 of the display panel 21 is used as a display area 60A for displaying the software keyboard 74 and an upper half of the software keyboard 74 is used as a display area 60B for displaying characters and the like. The display area 60A displays any selected characters and the like.

FIG. 7 shows a case where the displayed image is scrolled up and down. If a larger amount of information than that of the information the screen 60 of the display panel 21 can display is included, the displayed image is scrolled up and down using the second operation switch 48 so that an image displayed on the screen 60 of the display panel 21 can be successively displayed with it being scrolled. If any hyperlink in which an address 78 to be linked to a web browser is displayed is used in the displayed image, the displayed image is scrolled downwards as shown in FIG. 8 and then, the user touches a position of the touch panel 30 corresponding to the position of the display panel 21 in which the address 78 is displayed, with his or her finger so that any information linked to this address 78 can be displayed on the screen 60 of the display panel 21.

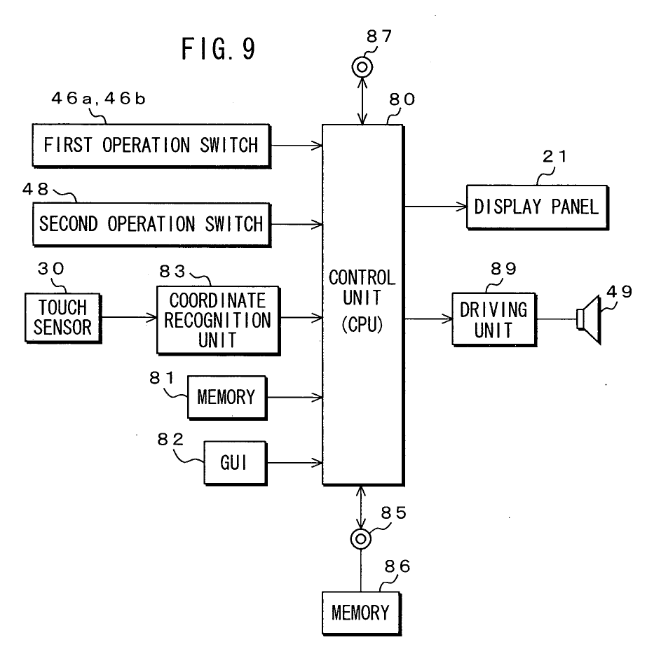

FIG. 9 shows an example of a control system in an embodiment of the portable terminal equipment 10 according to the invention. The control circuit board 44 contains a control unit (central processing unit (CPU)) 80 for controlling entire of the portable terminal equipment 10. To the control unit 80, a memory 81 in which various kinds of setting programs, working memory area or the like are maintained, a graphic user interface (GUI) 82 for displaying a specified image on the screen 60 of the display panel 21, the operation switches 46a, 46b, and 48, and the like are connected.

A coordinate recognition unit 83 that recognizes a touch position (corresponding to plane coordinates in the screen 60 of the display panel 21) on the touch sensor 30 is also connected to the control unit 80. When the coordinate recognition unit 83 supplies the control unit 80 with the coordinate information recognized therein, the control unit 80 controls various kinds of units to carry out the processing corresponding to the selected displayed items, such that the control unit 80 can control the display panel 21 to change the displayed images and display the changed image as well as to display a touch position.

In addition to the above processing, when any touch on the touch sensor 30 is detected, the control unit 80 controls the driving unit 89 to issue any buzzer sound from the speaker 49. The control unit 80 further performs writing and/or reading into/from the external storage device 86 that has been connected to the terminal 85 as well as performs any processing on any external information that has been received from the USB terminal 88.

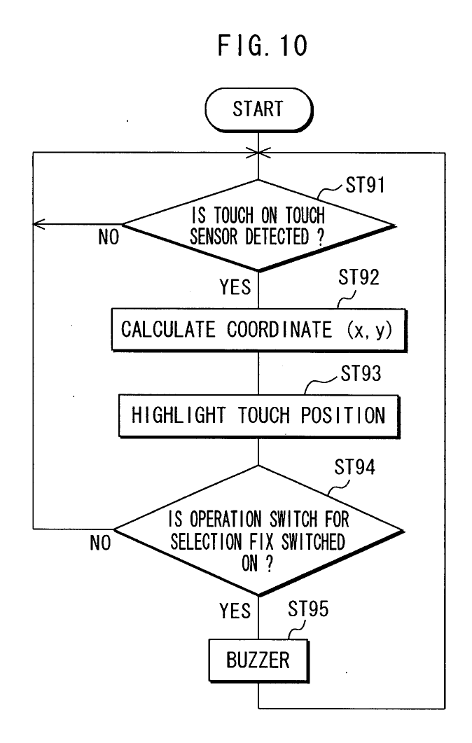

FIG. 10 shows a flowchart for showing an example of touch processing in this embodiment. This flowchart shows an example of touch processing from the touch on the touch sensor 30 toward fixation of the touch position.

At first, it is determined whether the touch on the touch sensor 30 is detected at step ST91. If the touch on the touch sensor 30 is detected at step ST91, the process goes to step ST92 where a coordinate (x, y) of the touch position is calculated. At step ST93, the corresponding characters or the like at the touch position are then highlighted.

At step ST94, the first operation switches 46a, 46b are checked in their operation states. Namely, it is determined whether the first operation switch 46a for selection fix is switched on or it is determined whether the first operation switch 46b for release is switched on. If it is determined at the step ST94 that the first operation switch 46b for release is switched on, then the process goes to an initial state. If it is determined at the step ST94 that the first operation switch 46a for selection fix is switched on, then the process goes to step ST95 where any buzzer sound is issued to notice this fixation and then, the process goes to the initial state.

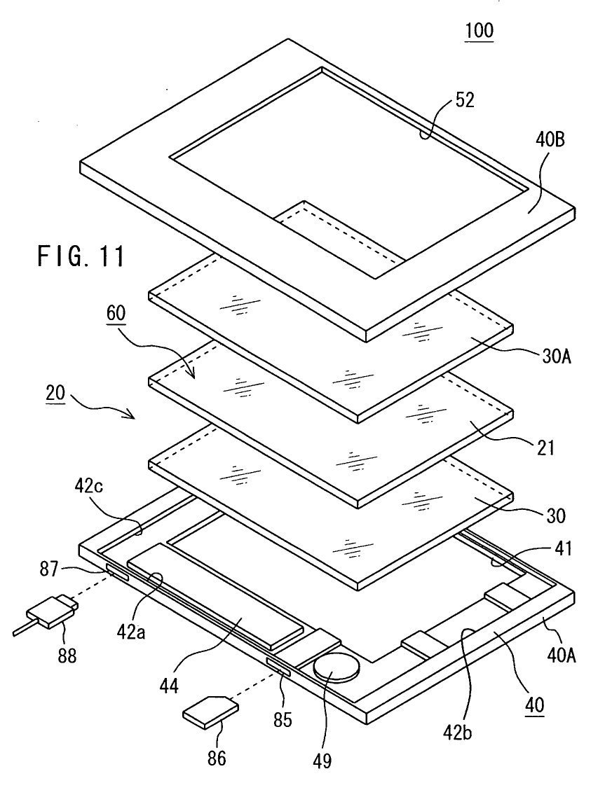

The following will describe another embodiment of the portable terminal equipment according to the invention. FIG. 11 illustrates an important portion of the above another embodiment of the portable terminal equipment 100. In this embodiment of the portable terminal equipment 100, instead of the first and second operation switches 46a, 46b, and 48 shown in FIG. 1, the touch sensor realizes any functions similar to those of the first and second operation switches 46a, 46b, and 48. Thus, these first and second operation switches 46a, 46b, and 48 are omitted from this embodiment. In this portable terminal equipment 100, in addition to the transparent touch sensor 30 mounting the transparent display panel 21, another transparent touch sensor 30A is mounted on the transparent display panel 21.

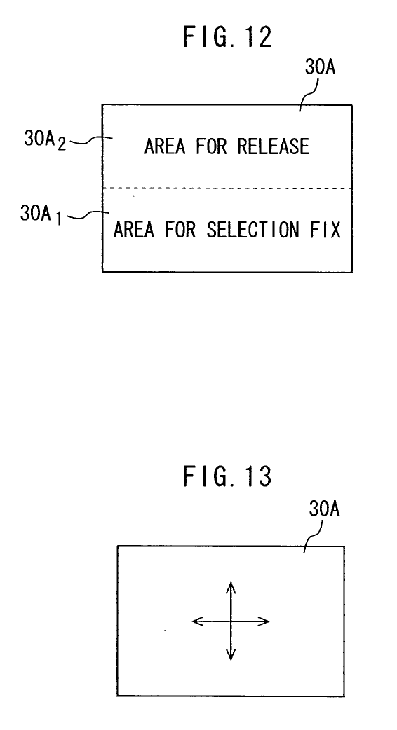

The touch sensor 30A has the same function as those of the first operation switches 46a, 46b and the second operation switch 48. First, the touch sensor 30A functions as sensors 30A₁, 30A₂ divided by two strips above and below in order to realize any functions similar to those of the first operation switches 46a, 46b, as shown in FIG. 12. For example, the lower sensor 30A₁ functions as a sensor for selection fix and the upper sensor 30A₂ functions as a sensor for release. In any optional touch position in each of the sensors 30A₁, 30A₂, the user can select any corresponding functions.

Alternatively, as shown in FIG. 13, in order to realize any functions similar to that of the second operation switch 48, when the user moves his or her finger (according to arrows shown in FIG. 13) vertically and horizontally on a surface of the touch sensor 30A starting from any optional touch position, the touch sensor 30A can function as a scroll sensor by scrolling an image displayed on the screen 60 of the display panel 21 up and down and/or right and left.

Thus, the touch sensor 30A having functions such as the selection fix function, the release function, and the scroll function, enables to be realized the same operations as those of the first and second operation switches 46a, 46b, and 48. This enables the casing 40 to be made compact as compared with the casing 40 shown in FIG. 1 because of lack of the first and second operation switches 46a, 46b, and 48. In this embodiment, even if the transparent touch sensor 30A is provided, the user can operate the portable terminal equipment 100 without blocking the user's view to an image displayed on the screen 60 of the display panel 21 with his or her hand or hands.

Although, in the above embodiments, the display panel 21 has been described as the monochrome display panel, this invention is not limited thereto. Any color display panel may be used as the display panel 21 in the embodiments of this invention.

Although, in the above embodiments, the display panel 21, the touch sensors 30, 30A have been described as the transparent display panel and the transparent touch sensors, this invention is not limited thereto. Any translucent display panel and translucent touch sensor though which the user's finger(s) can be viewed may be applied to the embodiments of the invention.

It should be understood by those skilled in the art that various modifications, combinations, sub-combinations and alternations may occur depending on design requirements and other factors insofar as they are within the scope of the appended claims or the equivalents thereof.

What is claimed is:

1. Portable terminal equipment comprising:
plane display device made of any one of transparent and translucent materials;
a touch sensor made of any one of transparent and translucent materials, said touch sensor mounting the plane display device; and
a casing that holds the plane display device by fastening the plane display device from both sides of the plane display device.

2. The portable terminal equipment according to claim 1 wherein the plane display device is constituted of a light-emitting display panel and its display-driving mechanism.
